(19) United States
(12) Patent Application Publication
(10) Pub. No.: US 2010/0324996 A1
(43) Pub. Date: Dec. 23, 2010

(54) ADVERTISING METHOD, SNS ADVERTISING SYSTEM AND RECORDING MEDIUM

(75) Inventors: Minkyoung Kim, Seoul (KR); Junesup Lee, Gyeonggi-do (KR)

Correspondence Address: LOWE HAUPTMAN HAM & BERNER, LLP, 1700 DIAGONAL ROAD, SUITE 300, ALEXANDRIA, VA, 22314, US

(73) Assignee: SK TELECOM. CO., LTD, Seoul (KR)

(21) Appl. No.: 12/666,148

(22) PCT Filed: Oct. 1, 2008
(86) PCT No.: PCT/KR08/05770

§ 371 Date: Dec. 22, 2009

(30) Foreign Application Priority Data
Dec. 8, 2007 (KR) 10-2007-0127253

(51) Int. Cl. G06Q 30/00; G06Q 99/00

(52) U.S. Cl. 705/14.66

(57) ABSTRACT

Disclosed is an advertising method, and a Social Networking Service (SNS) advertising system and a recording medium for performing the same. The advertising method includes: analyzing a Call Data Records (CDR) system for storing therein phone call details of user terminals, and extracting groups; receiving advertising information; searching for a user profile matching with the advertising information, and selecting at least one particular person having the user profile; selecting a target group including the particular person; and providing an advertisement to the selected target group. Accordingly, it is possible to effectively provide advertisements to user terminals connected to a wired/wireless communication network.

### TECHNICAL FIELD

The present invention relates to a method for providing an advertisement through a user terminal, and a Social Networking Service (SNS) advertising system and a recording medium for performing the same.

More particularly, the present invention relates to an advertising method, and an SNS advertising system and a recording medium for performing the same, where the advertising method extracts groups with close interaction formed over a wired/wireless communication network and provides advertisements to the extracted groups, or selects influential users and provides advertisements to the selected users.

### BACKGROUND ART

Now, service providers provide users with various advertisements of advertisers through various terminals.

When a user makes a request for a service to a service provider, it is usual that the user does not write their interests or hobbies or incorrectly write their interests or hobbies in the user profile. Therefore, conventional advertising methods provide advertisements for randomly-selected groups or groups selected based on ambiguous criteria, such as age, sex, and region.

Even when a user correctly writes his or her interests or hobbies in a user profile when the user requests a service, the user profile as described above does not accurately reflect recent interest or recent hobby of the user.

In addition, users cannot help receiving spam advertisements which are not related to themselves and cannot help failing to receive advertisements matching with current interests or hobbies of the users.

### DISCLOSURE

### Technical Problem

The present invention provides an advertising method, and an SNS advertising system and a recording medium for performing same, which effectively provide an advertisement to a user terminal connected to a wired/wireless communication network.

The present invention provides an advertising method, and an SNS advertising system and a recording medium for performing the same, which analyze a Call Data Records (CDR) system for storing therein phone call details of a user terminal, extract groups with close interaction formed over a wired/wireless communication network and provide advertisements to the extracted groups, or select the most influential users from the extracted groups and provide advertisements to the selected users. Accordingly, a user not only can avoid receiving an unnecessary spam advertisement, but can also receive only an advertisement reflecting recent interests or recent hobby of the user. Also, an advertiser can provide an advertisement to only members of a group having a large advertising effect or only largely influential users. Therefore, it is possible to maximize advertising while minimizing advertising costs. Further, a service provider provides an advertising service by using minimal resources.

### Technical Solution

The present invention provides a method of advertising by using a user terminal, and an SNS advertising system and a recording medium for performing the same.

In accordance with an aspect of the present invention, there is provided a method of advertising, the method including: analyzing a Call Data Records (CDR) system for storing therein phone call details of user terminals, and extracting groups; receiving advertising information; searching for a user profile matching with the advertising information, and selecting at least one particular person having the user profile; selecting a target group including the particular person; and providing an advertisement to the selected target group.

In accordance with another aspect of the present invention, there is provided a system of Social Networking Service (SNS) advertising, the system including: a Call Data Records (CDR) system for storing phone call records of user terminals therein; a memory unit for storing user profiles therein; a transceiver unit connected to a wired/wireless communication network, the transceiver receiving advertising information or providing an advertisement through a user terminal; and a control unit for analyzing the CDR system and extract groups, selecting at least one particular person having a user profile stored in the memory unit, which matches with the received advertising information, and selecting a target group including the particular person and providing an advertisement to the selected target group through the transceiver unit.

In accordance with further aspect of the present invention, there is provided a recording medium recording therein a program for implementing an advertising method, the recording medium including: a function of extracting groups by analyzing a Call Data Records (CDR) system for storing therein phone call details of user terminals; a function of receiving advertising information; a function of searching for a user profile matching with the advertising information and selecting at least one particular person having the user profile; a function of selecting a target group including the particular person; and a function of providing an advertisement to the selected target group.

### Advantageous Effects

According to the present invention, an advertisement can be effectively provided for a user terminal connected to a wired/wireless communication network. Accordingly, the user not only can avoid receiving an unnecessary spam advertisement, but can also receive only an advertisement reflecting recent interests or recent hobby of the user. Also, an advertiser can maximize advertising effect while minimizing advertising costs. Further, a service provider can provide an advertising service with use of minimal resources.

### DESCRIPTION OF DRAWINGS

The above and other exemplary features, aspects, and advantages of the present invention will be more apparent from the following detailed description taken in conjunction with the accompanying drawings, in which:

FIG. 1 is an explanatory view showing a configuration of a communication system according to an embodiment of the present invention;

FIG. 2 is a block diagram illustrating a configuration of an SNS advertising system shown in FIG. 1;

FIG. 3 is a block diagram illustrating a configuration of a memory unit shown in FIG. 2;

FIG. 4 is a block diagram illustrating a configuration of a control unit shown in FIG. 2;

FIG. 5 is an explanatory view showing the concept of analyzing a Call Data Records (CDR) system and extracting groups;

FIG. 6 is a flowchart showing an advertising method according to another embodiment of the present invention; and

FIGS. 7 and 8 are flowcharts showing advertising methods according to further embodiments of the present invention.

### MODES FOR INVENTION

Embodiments to be described below are use examples related to providing an advertisement, e.g. a mobile advertisement, by using CDR as user context, and specify requirements extracted from these use examples below.

According to the latest global Nielsen consumer report in October 2007, word-of-mouth is the most effective advertising means in that consumers first trust the recommendations of their close families, friends, colleagues, or acquaintances, and consumers perform most of their communications through their mobile phones. That is, the term “mobile advertisement” refers to not only a direct commercial advertisement to a particular user but also an indirect user advertisement that the particular user delivers to his/her communication group through his/her mobile phone.

We lead our lives while intentionally or unintentionally forming relation groups in a society. The relation groups, such as family, colleagues, friends, clubs, etc., are very diversified in their characters and purposes. However, if these relation groups as described above have common characteristics, there will be close interaction formed in each group. The close interaction implies that one belongs to the group and incessantly exchanges opinions with other members while sharing the exchanged opinions with the other members.

There is a high probability that a group with close relations between members as described above will have common interests. Namely, it may be more effective to do target marketing to groups, each of which has a high probability of having strong interaction and common interests between its members, than to provide advertisements to randomly-extracted individuals.

Accordingly, each of communication systems or advertising methods according to embodiments of the present invention extracts groups with close interaction formed over a wired/wireless communication network and provides advertisements to the extracted groups, or selects influential users and provides advertisements to the selected users.

### One Embodiment

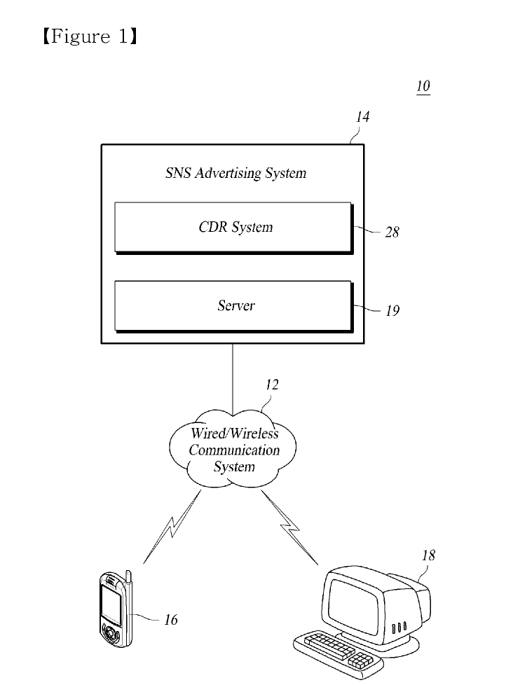

FIG. 1 is an explanatory view showing a configuration of a communication system according to an embodiment of the present invention.

Referring to FIG. 1, the communication system 10 according to an embodiment of the present invention includes an SNS advertising system 14 and a plurality of user terminals 16 and 18 interconnected through a wired/wireless communication network 12.

According to an embodiment of the present invention, the wired/wireless communication network 12 refers to a mobile communication network.

The SNS advertising system 14 provides a communication service to the user terminals 16, 18, etc. through the wired/wireless communication network 12 for communication of the user terminals 16, 18, etc. Particularly, according to the present embodiment, the SNS advertising system 14 refers to a service provider (e.g. A-Mobile or an operator server thereof) for selecting an advertisement and providing a mobile advertising service based on user information (e.g. a user profile and an IDentification (ID) of a group with which a particular user interacts very closely).

Also, the user terminals 16 and 18 include wired/wireless communication terminals capable of communication via a wired/wireless communication network, such as a computer, a notebook computer, a Personal Digital Assistant (PDA), a cellular phone, Personal Communication Service (PCS) phone, a handheld Personal Computer (PC), a Global System for Mobile (GSM) phone, a Wideband Code Division Multiple Access (W-CDMA) phone, a CDMA-2000 phone, a Mobile Broadband System (MBS) phone, etc.

Particularly, in the specification of the present invention, the term “user” refers to one who consumes an advertising service.

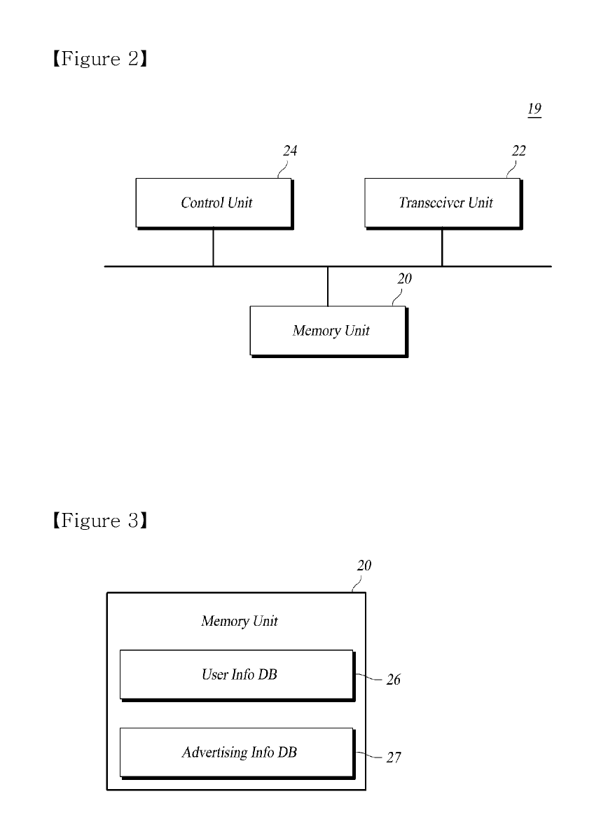

FIG. 2 is a block diagram illustrating a configuration of a service provider server shown in FIG. 1.

Referring to FIG. 1, the SNS advertising system 14 includes a CDR system 28 and the service provider server 19.

The CDR system 28 stores therein phone call results of subscribers and real-time statistics on phone calls of them. Accordingly, the CDR system 28 includes information related to all communications through a phone call or an e-mail exchange.

A conventional CDR system extensively includes all information for fee charge and personal inclinations of subscribers, etc. On the other hand, the CDR system 28 according to an embodiment of the present invention may include only phone call details of the user terminals 16 and 18 in a range required to extract groups with close interaction formed over the wired/wireless communication network 12 and provide advertisements to the extracted groups, or select only influential users and provide advertisements to the selected users. The CDR system 28 may be newly and separately implemented within a scope suitable for an embodiment of the present invention, or may be implemented by a CDR system with only a scope required for an embodiment of the present invention from among conventional CDR systems.

The CDR system 28 records therein the identities of sources (points of origin), the identities of destinations (endpoints), the duration of each call, the amount billed for each call, the total usage time in the billing period, the total free time remaining in the billing period, and the running total charged during the billing period. Table 1 below shows an example of a phone call record recorded in the CDR system 28.

TABLE 1

| Column | Example data | Description |
|---|---|---|
| TIMESTAMP | 2007-11-28 | The date and time the |
| | 08:40:33 | call is made |
| LOGIN | ANOther.61234 | The login ID used to |
| | | make the call |
| SOURCE_ADDRESS | 373993939393 | The telephone number |
| | | of sender |
| DESTINATION_ADDRESS | 4477009123456 | The telephone number |
| | | of recipient |
| STATUS_TIMESTAMP | 2007-11-28 | The date and time of |
| | 08:43:34 | current status |
| STATUS | Accepted | The latest status of the |
| | | call |

The CDR system 28 with the phone call record as shown in Table 1 can be used to provide user's dynamic information for the right selection and performing an advertisement. Since dynamic social networking information is extracted from the CDR system 28, the CDR system 28 gives importance based on user context.

As used herein, the user context refers to a current state of a user and dynamic information representing the surroundings of the user.

Specific user context information extracted from the CDR system 28 includes: (1) Social Community Identification to which a user currently belongs, (2) Customer Network Value in a community, and (3) The number of communities to which a user currently belongs, etc.

At this time, in relation to Social Community Identification to which a user currently belongs, the SNS advertising system 14 can extract communities, each of which has strong interaction between its members, from the entire communication network by analyzing the CDR system 28. These communities as described above are advertising targets. One of advertising methods described below targets advertisement to these communities.

In relation to Customer Network Value in a community, the SNS advertising system 14 may select, from the CDR system 28, a user with the greatest influence on spreading advertising information in a community. The user as described above is also an advertising target. One of advertising methods described below targets advertisement to these users.

The number of communities to which a user currently belongs refers to the type of diversity measure of user activities. The SNS advertising system 14 may extract a type of diversity measure of user activities from the CDR system 28.

Also, by using a part of user context, the SNS advertising system 14 may obtain more extensive information than each user context itself from the CDR system 28. For example, the SNS advertising system 14 can extract, from the CDR system 28, a Community Network Value from all communities, such as (4) Characteristics of a community, such as age, domain, etc., (5) Size of a community, such as the largest community in a particular domain, and (6) which community has the greatest influence on spreading marketing information.

In this case, the server 19 includes a memory unit 20, a transceiver unit 22, and a control unit 24.

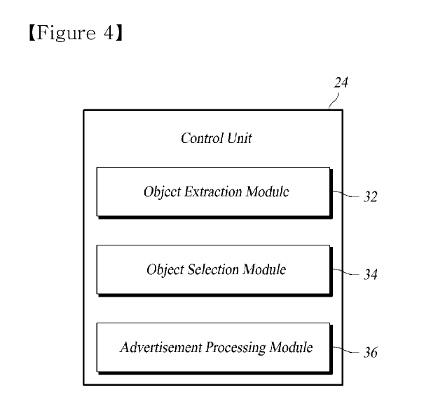

The memory unit 20 stores therein user information of users, and advertising information including an advertising object for a particular advertisement requested by an advertiser and characteristics of target users in relation to the particular advertisement. FIG. 3 is a block diagram illustrating a configuration of a memory unit shown in FIG. 2.

Referring to FIGS. 2 and 3, the memory unit 20 includes a user information DataBase (DB) 26 and an advertising information DB 27.

The user information DB 26 includes various information related to users, such as a user profile including name, age, address, sex, hobby, interests, etc., all of which are written by the user when making a request for a service to a service provider or updating his/her user profile, information indicating whether a user has received an e-mail or a character message, and information indicating whether the user uses each service.

Table 2 below shows an example of a user profile stored in the user information DB 26.

TABLE 2

| | User profile |
|---|---|
| Name | Jack KIM |
| Age | 28 |
| Address | New York |
| Sex | Male |
| Interest | Photography |

Also, the advertising information DB 27 stores therein advertising information including an advertising object for a particular advertisement requested by an advertiser and characteristics of target users in relation to the particular advertisement. Herein, the term “advertiser” refers to one who desires to increase sales of his/her own product or service through a mobile advertising service of a service provider. Table 3 below shows an example of advertising information stored in the advertising information DB 27.

TABLE 3

| Advertiser | MindyDigitalCamera.com |
|---|---|
| Advertising object (product or service) | Digital camera |
| Characteristics of target users | Age from twenties to thirties |

The transceiver unit 22 is connected to the wired/wireless communication network 12, and receives the characteristics of target users in relation to a particular marketing or transmits particular marketing information to a user terminal. For example, the transceiver unit 22 includes an advertising object communication reception module and an advertising performance module. Herein, the advertising object communication reception module receives, from an advertiser, the characteristics (e.g. age, sex, a place of residence, interests, etc.) of consumers to be targeted by an advertisement. Upon receiving a list of final advertisement target people from the control module 24, the advertising performance module transmits an advertising message to the advertisement target people.

The control unit 24 analyzes the CDR system 28 to extract groups, selects at least one particular person having user information stored in the memory unit 20, which matches with the received advertising object, and selects a target group including the particular person through the transceiver unit 22 and provides an advertisement to the selected target group.

At this time, the target group may be a group related to the characteristics of target users of a particular marketing from among at least one group including the particular person.

Also, the control unit 24 can periodically analyze the CDR system 28 and extract a target group related to the latest user. The control unit 24 extracts a group based on a degree of cohesion between users, or extracts users with strong cohesion between users as a group.

Specifically, the control unit 24 includes an object extraction module 32, an object selection module 34, and an advertisement processing module 36.

The object extraction module 32 periodically analyzes the CDR system 28, and extracts a group based on a degree of cohesion between users, or extracts users with strong cohesion between users as a group. At this time, in order to extract groups related to users by periodically analyzing the CDR system 28, the object extraction module 32 may use various algorithms used in a social network analysis algorithm and/or a community analysis algorithm.

For example, according to an embodiment of the present invention, in order to extract groups related to users by periodically analyzing the CDR system 28, the object extraction module 32 may use a CNM algorithm (A. Clauset, M. E. J. Newman, and C. Moore. Finding Community Structure in Very Large Networks. Physical Rewiew E, 70:066111, 2004, cond-mat/0408187.), an algorithm obtained by implementing the CNM algorithm in a Mega-scale social network (Ken Wakita and Toshiyuki Tsurumi, Finding Community Structure in Megascale Social Networks, 2007. 1. 8), and the like (if necessary, theses or algorithms mentioned in the the present specification may be incorporated into the present specification as a part thereof).

The second algorithm determines a community naturally existing in a network based on the “Min-Max Cut” criterion for minimizing a link between groups and maximizing a link in a group.

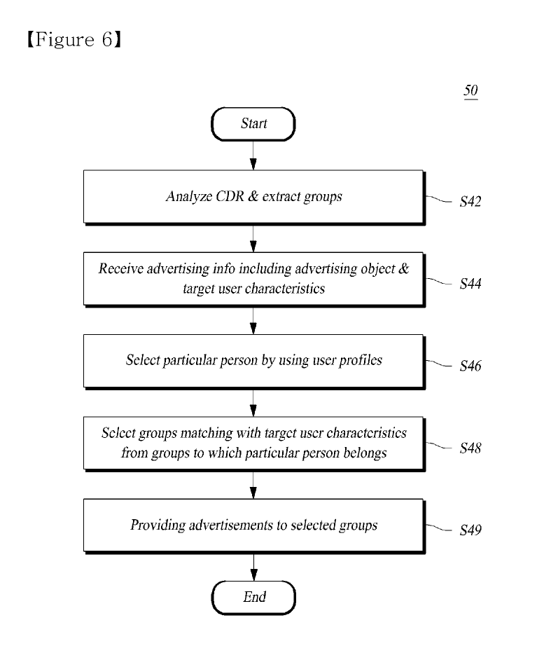

FIG. 5 is an explanatory view showing the concept of analyzing the CDR system and extracting groups.

As illustrated in FIG. 5, the object extraction module 32 periodically analyzes the CDR system 28 by using the algorithms as mentioned above or other algorithms. Therefore, the object extraction module 32 can extract groups based on a degree of cohesion of users, or extract users with strong cohesion between users as a group.

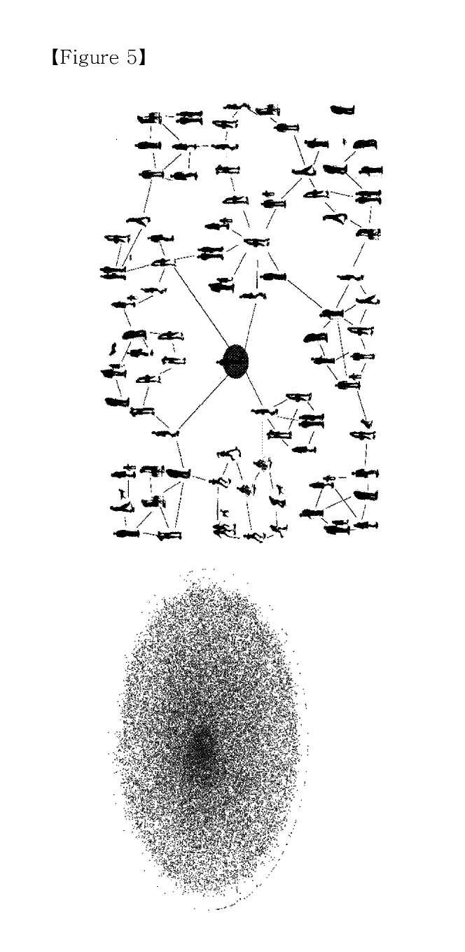

Returning again to FIG. 4, the object selection module 34 selects at least one particular person having user information matching with advertising information stored in the memory unit 20. For example, the object selection module 34 finds at least one user matching with an advertising object (e.g. a digital camera) which is one piece of information from among the advertising information stored in the memory unit 20.

The advertisement processing module 36 may select all groups including the found users as target groups, and provide advertisements to the selected target groups through the transceiver unit 22. Also, in order to maximize advertising effect, the advertisement processing module 36 may select only groups, which satisfy conditions (see the “Characteristics of target users” field in Table 3) on the characteristics of target users with respect to a digital camera obtained from a site (e.g. MindyDigitalCamera.com) of an advertiser, for example, groups including young generations in age of twenties and thirties or groups including users having satisfying user profile items such as age and interests (see the “Age” field of the User profile in Table 2), as target groups, from among the groups including the found users, and provide advertisements to the selected target groups through the transceiver unit 22.

For example, from among groups including Jack KIM, who is one of users selected by the object selection module 34, the advertisement processing module 36 may select groups, on which information of user profiles (see the “Age” field of User profile in Table 2) stored in the user information DB 26 coincides with the characteristics (e.g. age in twenties and thirties) of target users (see the “Characteristics of target users” field in Table 3) provided by an advertiser, as target groups, and provide advertisements to the selected target groups.

As another example, in the case of advertising perfume, from among groups to which Julia CHO, who is one of users selected by the object selection module 34, belongs, the advertisement processing module 36 may select groups, on which information of user profiles (see the “Age” field and “Sex” field of the User profile in Table 2) stored in the user information DB 26 coincides with the characteristics (see the “Characteristics of target users” field in Table 3) of target users (e.g. women in age of twenties and thirties) provided by an advertiser.

The examples described above show only cases where the target user characteristic is a particular age range or the female sex in selection of target groups by the advertisement processing module 36 based on matching between the target user characteristic presented by an advertiser and the user profile stored in the user information DB 26. However, the advertisement processing module 36 may use various other elements according to hobbies and regions as the target user characteristics in selection of target groups based on matching between the target user characteristic presented by an advertiser and the user profile stored in the user information DB 26.

Users dynamically form communication groups by using the communication system 10, the SNS advertising system 14, and the user terminals 16 and 18 (e.g. the mobile phone 16) according to an embodiment of the present invention as described above. There is a high possibility that groups recently interacting with a user will have interests identical or similar to those of the user. Also, a service provider provides an advertisement with reference to a user profile of a particular user belonging to the group (static or dynamic user information). Therefore, members of the group can receive adaptive advertisements even when they have not specified or updated their own user profiles.

Meanwhile, since the CDR system 28 provides all phone call records including subscribers of other wireless operators, an advertiser need not consider all service providers who will perform the advertisement. Namely, the advertiser can reduce mobile advertising costs by selecting only one particular service provider.

Although a service provider does not know all user profiles, the service provider can guess recent interests of users through a record of interaction between closely-related groups provided by the CDR system 28.

### Another Embodiment

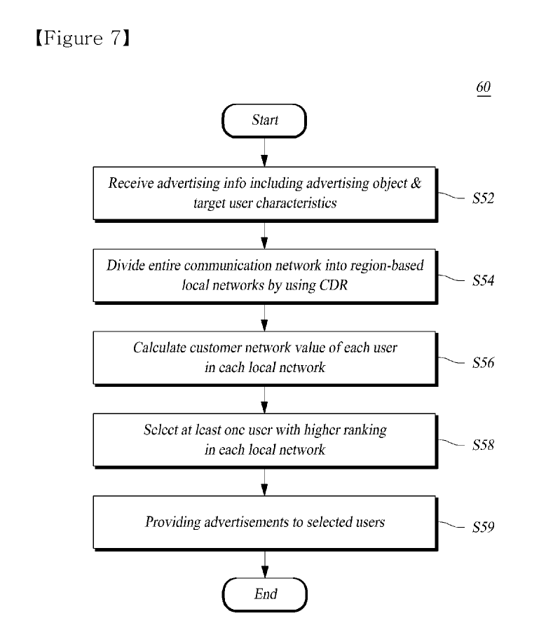

FIG. 6 is a flowchart showing an advertising method according to another embodiment of the present invention. Although the advertising method mainly uses the communication system 10, the SNS advertising system 14, and the user terminals 16 and 18 as described above, it may use another communication system, communication apparatus, or user terminal, further to them.

Referring to FIG. 6, when a particular user is selected with respect to a mobile advertisement according to the user's own taste, since there is a high possibility that both the particular user and members of the group including the particular user have the same or a similar hobby, not only the particular user but also groups closely interacting with the particular user is targeted by the mobile advertisement in the advertising method 40 according to another embodiment of the present invention targets. A service provider expands the advertising target from the particular user to the groups strongly interacting with the originally targeted particular user.

Specifically, one who consumes an advertising service, for example, Jack, is a member of an amateur digital camera club. At weekend, he takes photographs along with members of his club, and the club members usually exchange opinions with respect to their jobs through their mobile phones 16. Jack is a subscriber to a particular communication service named “A-Mobile,” other members are subscribers to another communication service named “B-Mobile” or “C-Mobile,” and Jack and they have the user terminals 16 and 18 as shown in FIG. 1.

In another aspect, a user generates a user profile to be stored in the memory unit 20, and specifies types of advertisements which the user receives or desires to receive. Since users usually do not specify or update their user profiles, it is hard to know recent interests or recent taste of each user. On the other hand, a static user profile includes basic items (e.g. sex, age, a date of birth, etc.) that do not change.

A site (e.g. MindyDigitalCamera.com) of an advertiser desires to advertise a new digital camera designed for a young generation.

A service provider (e.g. A-Mobile) is an owner or at least an operator of the apparatus or server 14 as shown in FIGS. 1 and 2, and selects an advertisement and provides a mobile advertising service based on user information (e.g. a user profile, an ID of a group with which a particular user very closely interacts).

A service provider needs to pay attention to some users registered in another wireless operator, who appear in a wireless communication network and may become potential customers. Also, it is necessary to periodically analyze the CDR system 29 in order to reflect dynamic user interaction information which can be an important element for right selection and in performing an advertisement.

In order to receive appropriate advertisements, a user previously specifies his/her user profile which includes the most important data on preference. An advertiser provides a service provider with necessary conditions on the characteristics of target users.

As shown in FIG. 6, first, the service provider, A-Mobile, periodically analyzes the CDR system 28 so that the CDR system 28 can be used as dynamic user context temporally in sequence. The service provider extracts, from the entire mobile communication network, communities/groups each of which has strong interaction between its members (i.e. users) (S42). At this time, it should be understood throughout the specification that a community and a group substantially have the same meaning.

As described above, in order to extract groups related to users by periodically analyzing the CDR system 28, the advertising method may use various algorithms used in a social network analysis algorithm and/or a community analysis algorithm. For example, the advertising method may use a CNM algorithm (A. Clauset, M. E. J. Newman, and C. Moore. Finding Community Structure in Very Large Networks. Physical Rewiew E, 70:066111, 2004, cond-mat/0408187.), an algorithm obtained by implementing the CNM algorithm in a Mega-scale social network (Ken Wakita and Toshiyuki Tsurumi, Finding Community Structure in Megascale Social Networks, 2007. 1. 8), and the like.

Then, the advertiser provides the service provider with characteristics of a target user in relation to a particular advertisement. A site (e.g. MindyDigitalCamera.com) of the advertiser provides the service provider (i.e. A-Mobile) with an advertising object (i.e. a digital camera) and conditions on the characteristics of target users (e.g. a group with age of twenties and thirties). The service provider (i.e. A-Mobile) receives the advertising object (i.e. the digital camera) and the conditions on the characteristics of the target users (e.g. a group with age of twenties and thirties) (S44). Needless to say, the service provider stores the received advertising information in the advertising information DB 27. Herein, the service provider may be conventionally understood to be the same as the SNS advertising system 14 as shown in FIGS. 1 and 2, or may be understood to be different from the SNS advertising system 14.

Next, the service provider searches the user information DB 26 storing user profiles in order to select appropriate users having user profiles matching with the characteristics of target users provided by the advertiser. The service provider (i.e. A-Mobile) searches the user information DB 26 storing user profiles matching with users, who have age of twenties to thirties and interests corresponding to photography, and selects Jack as one of users suitable for the mobile advertising service (S46).

In step S48, the service provider selects groups, which include profile-matching users selected in step S46 and have strong interaction with one another, from among groups already extracted in step S42, as target groups (S48). Jack's amateur digital club is one of the selected target groups.

Then, the service provider advertises the digital camera to the selected user groups (S49). Members of the amateur digital club receives mobile advertisements for new products of the site (e.g. MindyDigitalCamera.com) of the advertiser from the service provider (i.e. A-Mobile).

As a result, all members of the selected groups receive advertisements of the service provider. Meanwhile, the advertiser is aware that advertisements of the advertiser have been delivered to the most appropriate target groups through the service provider and the attracting force and recognition degree of the brand of the advertiser have been maximized. Then, the service provider provides a mobile advertising service to the members of the selected target groups.

Although it is shown in FIG. 6 that the step (S42) of extracting groups by analyzing the CDR system 28 precedes the step (S44) of receiving advertising information in the advertisement method 40 according to the present embodiment as described above, the present invention is not limited to this embodiment. Namely, in the present invention, the step of receiving advertising information may precede the step of extracting groups by analyzing the CDR system 28, or may be performed parallely with the step of extracting groups by analyzing the CDR system 28.

Meanwhile, although it has been described that, in step S48, the service provider selects groups, which include profile-matching users selected in step S46 and have strong interaction with one another, from among groups already extracted in step S42, as target groups, the service provider may select, as target groups, all groups including the profile-matching users selected in step S46 from among groups already extracted in step S42. Namely, when an advertiser intends to strengthen an advertisement designed for an individual, the advertiser may selects the former scheme. In contrast, when an advertiser intends to extend the range of advertisements, the advertiser may select the latter scheme.

### Another Embodiment

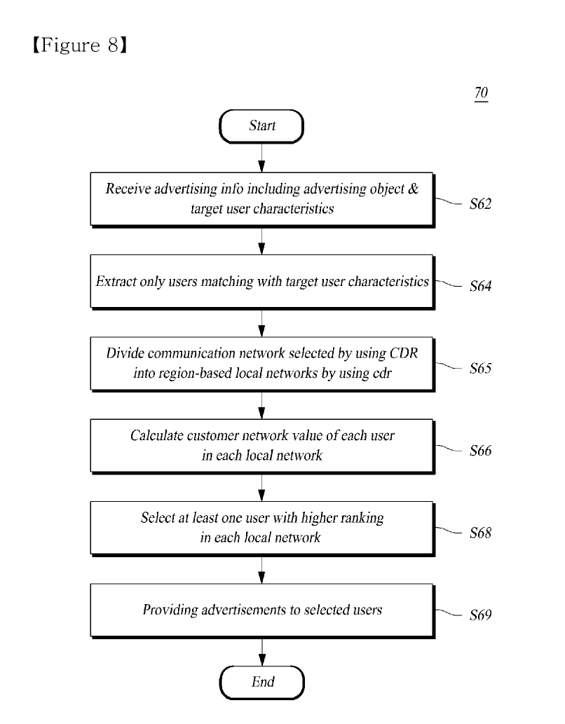

FIG. 7 is a flowchart showing an advertising method according to another embodiment of the present invention.

In the advertising method 50 according to another embodiment of the present invention, a service provider selects the most influential user belonging to a community/group in order to spread an advertisement.

Specifically, a user consumes an advertising service through the mobile phone 16, and distributes advertisements to his/her acquaintances. The user allows reception of the advertisements, and thus can receive some incentives, such as a discount coupon. These advertisements can be used as user context when matching with user information such as a user profile.

An advertiser desires to promote a product or a service of the advertiser through a mobile advertising service of a service provider at the lowest cost. The service provider selects a marketing target, which is most influential in distributing the advertisement in a communication network. Therefore, the advertiser can perform effective marketing at the lowest cost.

The service provider selects an advertisement and provides a mobile advertising service based on user information (e.g. a user profile and a Customer Network Value in a communication network). The service provider needs to determine a target network range from estimated Customer Network Values based on the requirements of the advertiser on an advertising object.

Instead of statically calculating a Customer Network Value in the communication network based on interests, etc. in a user profile written when a user subscribes to a service, the service provider periodically analyzes the CDR system storing recent phone call results of users, dynamically estimates a Customer Network Value of each user in the communication network, and uses the estimated Customer Network Value as a network profile. Also, the service provider provides advertisements to only influential users in order to reduce advertising costs, differently from the conventional advertising methods, which provide advertisements to randomly-extracted users. Therefore, such reduction of advertising costs can attract advertisers.

In order to receive appropriate advertisements, a user previously specifies the most significant data on preference for his/her user profile.

As shown in FIG. 7, an advertiser first sends requirements (e.g. age, region, interests, etc.) for target marketing to a service provider. For example, an advertising target provided by the advertiser may be a group ranging in age from twenties to thirties.

Namely, a site (e.g. MindyDigitalCamera.com) of the advertiser provides the service provider (i.e. A-Mobile) with an advertising object (i.e. a digital camera) and conditions on the characteristics of target users (e.g. a group ranging in age from twenties to thirties). The service provider (i.e. A-Mobile) receives the advertising object (i.e. the digital camera) and the conditions on the characteristics of the target users (e.g. a group ranging in age from twenties to thirties) (S52). Needless to say, the service provider stores the received advertising information in the advertising information DB 27.

Then, the service provider divides the entire communication network into multiple region-based local networks by using the CDR system 28 (S54).

In order to divide the entire communication network into multiple region-based local networks by using the CDR system 28, the advertising method 50 may use various algorithms used in a social network analysis algorithm and/or a community analysis algorithm. For example, the advertising method 50 may use a Two-way Multi-level Partitioning Algorithm (a Fast and High Quality Multi-level Scheme for Partitioning Irregular Graphs, George Karypis and Vipin Kumar, 1997), and the like.

A Multi-way Multi-level Partitioning Algorithm recursively performs two-way multi-level partitioning for dividing a network into two partitions, and finds a 2ⁿ (2 raised to the nth power) partitions. Namely, the Multi-way Multi-level Partitioning Algorithm classifies nodes in a network into two node groups, forms two networks, each of which includes only a relevant node group, and then performs two-way multi-level partitioning again on each network.

Then, the service provider calculates a Customer Network Value of each user in a local network (S56). The Customer Network Value refers to a propagation degree of information.

Namely, a Customer Network Value of each user represents a total sum of all Customer Network Values of other users having communicated with the user, including the Customer Network Value of the relevant user, A Customer Network Value can be calculated from both a number of phone calls (i.e. telephone traffic) and a diversity of phone calls of each user obtained by analyzing phone call details of users stored in the CDR system 28. Herein, the number of phone calls of each user represents the number of times that a relevant user talks over the telephone during a predetermined period of time. A diversity of phone calls of each user represents diversity of communication counterparts, which indicates how different parties a relevant user has communicated with over the telephone during a predetermined period of time. Accordingly, the larger the number of phone calls and the diversity of phone calls of a user, the larger the Customer Network Value of the user.

As a result, the priority in the Customer Network Value of each user is proportional to the magnitude of the number of phone calls and the diversity of phone calls of both the user and communication counterparts of the user. At this time, it is needless to say that a range of users included in the calculation of a Customer Network Value, that is, a level or depth included in the calculation, such as user 1, user 2 having communicated with user 1, user 3 having communicated with user 2, etc., can be determined according to the advertising purposes. For example, a Customer Network Value of each user may be set to a total sum of Customer Network Values of multi-level users of 10 levels.

The Customer Network Value can be understood to have similar meaning to Social Networking Potential (SNP) indicating the propagation degree of information in viral marketing and viral advertising (see viral marketing described in www.wikipedia.org)

Next, the service provider selects users ranging in age from twenties to thirties, who are most influential in each local network (S58). The number of target users is at least one who has a high ranking in a relevant local network.

Namely, the term “user with great influence” refers to a user with a large Customer Network Value of a high ranking. A user with a large Customer Network Value corresponds to not only a user having a large number of times of his/her own communication and various communication counterparts, but also a user the counterparts' of whom also have a large number of times of communication and various other communication counterparts. Each of users with large Customer Network Values inevitably has a large influence for spreading information (e.g. advertising information) obtained by himself/herself to a third party.

Finally, the service provider provides advertisements to the selected target users (S59).

### Another Embodiment

FIG. 8 is a flowchart showing an advertising method according to another embodiment of the present invention.

Referring to FIG. 8, an advertising method 60 according to another embodiment of the present invention is, on the whole, the same as the advertising method 50 as described above, except for the replacement of step S54 by steps S64 and S65.

Specifically, a service provider (i.e. A-Mobile) receives an advertising object (i.e. a digital camera) and conditions on the characteristics of target users (e.g. a group ranging in age from twenties to thirties) (S62). Needless to say, the service provider stores the received advertising information in the advertising information DB 27.

Next, the service provider extracts only users ranging in age of twenties and thirties from the entire network (S64). Then, the service provider divides a communication network selected by using the CDR system 28 into multiple region-based local networks (S65). The service provider may use various algorithms as described above as an algorithm by which the service provider divides the communication network selected by using the CDR system 28 into multiple region-based local networks.

Remaining steps are the same as the steps of the advertising method 50 as described above with reference to FIG. 7. Namely, the service provider calculates a Customer Network Value of each user in a local network (S66). The Customer Network Value of each user is the same as described above, and therefore a detailed description will be omitted.

Next, the service provider selects users ranging in age from twenties to thirties, who are most influential in each local network (S68). Finally, the service provider provides advertisements to the selected target users (S69).

As a result, a user with the greatest influence receives an advertisement from the service provider according to his/her own user profile.

Therefore, an advertiser can understand that advertisements of the advertiser have been provided to the users with the greatest influence and the range of spreading advertisements has been maximized at the lowest cost.

The service provider provides a mobile advertising service to the selected users.

### Another Embodiment

An advertising method according to another embodiment of the present invention can be implemented as a program readable by a computer in a recording medium readable by the computer.

The program recorded in the recording medium for implementing the advertising method performs: a function of analyzing a CDR system storing therein phone call details of user terminals and extracting groups; a function of receiving advertising information; a function of searching for a user profile and selecting at least one particular person having the user profile matching with the advertising information; a function of selecting a target group including the particular person; and a function of providing an advertisement to the selected target group.

The advertising information as described above may include at least one of an advertising object for a particular advertisement and characteristics of target users in relation to the particular advertisement.

When the advertising information includes the advertising object for the particular advertisement, the function of selecting at least one particular person may select at least one particular person having a user profile matching with the advertising object.

When the advertising information received during execution of the function of receiving advertising information includes characteristics of target users in relation to a particular advertisement, the target group selected during execution of the function of selecting a target group may be a group related to the characteristics of the users to be targeted by the particular advertisement from among at least one group including the particular person. Herein, the advertising information including the characteristics of the target users in relation to the particular advertisement may include the advertising object as described above.

The function of extracting groups may extract a group based on a degree of cohesion between users, or may extract users with strong cohesion between users as a group.

The computer-readable recording medium that records therein the program for implementing the advertising method according to the present embodiment includes all types of recording devices readable by the computer. Examples of the recording medium readable by a computer include a Read Only Memory (ROM), a Random Access Memory (RAM), a magnetic tape, a floppy disc, an optical data storage device, etc. and also include a recording device implemented in the form of carrier waves (e.g. in the form of transmission over the Internet). Further, the recording mediums readable by the computers can be distributed in a computer system connected to a network, and codes readable by the computers can be stored in the recording mediums and can be performed in a distributed manner.

In addition, programmers skilled in the art to which the present invention pertains can easily infer functional programs, codes, and code segments for implementing the present invention.

Although the embodiments of the present invention have been described with reference to the accompanying drawings, as described above, the present invention is not limited to these embodiments as described above.

Although it has been described in an embodiment of the present invention that the communication system, the server, and the user terminals mainly perform the advertising method 40 described with reference to FIG. 6, the present invention is not limited to this embodiment. Namely, they may also perform the advertising methods 50 and 60 respectively described with reference to FIGS. 7 and 8. Namely, the steps or operations of the advertising methods 50 and 60 performed by the service provider may be performed by the SNS advertising system 14 as shown in FIGS. 1 and 2. Particularly, the control unit 24 of the SNS advertising system 14 can divide the entire communication network into multiple region-based local networks by using the CDR system 28, calculate a Customer Network Value of each user in a local network, and select users ranging in age from twenties to thirties with the greatest influence in each local network. The memory unit and the transceiver unit of the SNS advertising system 14 perform functions which are substantially the same as the functions as described above.

The above-described embodiments employ a mobile communication terminal or mobile phone as an example of a user terminal. As described above with reference to the latest global Nielsen consumer report (October 2007), most users communicate with the other parties through their mobile phones, and therefore it may be natural that an advertising service should be performed to some extent through a mobile phone. However, another user terminal (e.g. a computer, a television set) still takes the place of the function or role of the mobile communication terminal or mobile phone, and vice versa. Accordingly, the present invention may be performed by using user terminals other than the mobile communication terminals or mobile phones. For example, the SNS advertising system may analyze the CDR system to extract communities/groups with the same interests as particular users or users with large effects on spreading advertisements, and provide them with not only a mobile advertisement service but also an e-mail advertising service as an actual advertisement.

Although it has been described in the above embodiments that phone call records stored in the CDR system are mostly records of making phone calls, the present invention is not limited to these embodiments. For example, the phone call records stored in the CDR system may be phone call records related to message transmission/reception or messengers. In this case, the message includes various messages, such as an e-mail, a Short Message Service (SMS) message, Multimedia Message Service (MMS) message, etc.

Although it has been described in the embodiments as described above that the CDR system is included in the SNS advertising system, the present invention is not limited to these embodiments. For example, the CDR system may be configured separately from the SNS advertising system. Also, the CDR system may be included in the server, or may be included a separate server while being connected to a wired/wireless communication network.

Although exemplary embodiments of the present invention have been described for illustrative purposes, those skilled in the art will appreciate that various modifications, additions and substitutions are possible without departing from the scope and spirit of the present invention as disclosed in the accompanying claims. Therefore, the embodiments disclosed in the present invention do not restrict but describes the idea of the art in the present invention, and do not restrict the scope of the idea of the art in the present invention. The scope of protection of the present invention should be interpreted by the appended claims, and all ideas of the arts falling within the scope equivalent to the appended claims should be interpreted as falling within the scope of right of the present invention.

1. A method of advertising, which comprises:
analyzing a Call Data Records (CDR) system for storing therein phone call details of user terminals, and extracting groups;
receiving advertising information;
searching for a user profile matching with the advertising information, and selecting at least one particular person having the user profile;
selecting a target group including the particular person; and
providing an advertisement to the selected target group.

2. The method as claimed in claim 1, wherein the advertising information comprises an advertising object for a particular advertisement, and in the selecting at least one particular person, at least one particular person whose user profile matches with the advertising object is selected.

3. The method as claimed in claim 1, wherein the advertising information received in the step of receiving advertising information comprises characteristics of target users in relation to a particular advertisement, and the target group selected in the step of selecting a target group corresponds to a group related to the characteristics of the target users in relation to the particular advertisement from among at least one group including the particular person.

4. The method as claimed in claim 3, wherein, in the extracting groups, a group is extracted based on a degree of cohesion between users, or users with strong cohesion between users are extracted as a group.

5. A system of Social Networking Service (SNS) advertising, the system comprising:
a Call Data Records (CDR) system for storing phone call records of user terminals therein;
a memory unit for storing user profiles therein;
a transceiver unit connected to a wired/wireless communication network, the transceiver receiving advertising information or providing an advertisement through a user terminal; and
a control unit for analyzing the CDR system and extract groups, selecting at least one particular person having a user profile stored in the memory unit, which matches with the received advertising information, and selecting a target group including the particular person and providing an advertisement to the selected target group through the transceiver unit.

6. The system as claimed in claim 5, wherein the advertising information comprises an advertising object for a particular advertisement, and the control unit selects at least one particular person, the user profile of whom matches with the advertising object.

7. The system as claimed in claim 5, wherein the advertising information received through the transceiver unit comprises characteristics of target users in relation to a particular advertisement, and the target group corresponds to a group related to the characteristics of the target users in relation to the particular advertisement from among at least one group including the particular person.

8. The system as claimed in claim 7, wherein the control unit extracts a group based on a degree of cohesion among users, or extracts users with strong cohesion between users as a group.

9. A recording medium recording therein a program for implementing an advertising method, the recording medium comprising:
a function of extracting groups by analyzing a Call Data Records (CDR) system for storing therein phone call details of user terminals;
a function of receiving advertising information;
a function of searching for a user profile matching with the advertising information and selecting at least one particular person having the user profile;
a function of selecting a target group including the particular person; and
a function of providing an advertisement to the selected target group.

10. The recording medium as claimed in claim 9, wherein the advertising information comprises an advertising object for a particular advertisement, and the function of selecting at least one particular person selects at least one particular person, the user profile of whom matches with the advertising object.

11. The recording medium as claimed in claim 9, wherein the advertising information received by performing the function of receiving advertising information comprises characteristics of target users in relation to a particular advertisement, and the target group selected by performing the function of selecting a target group corresponds to a group related to the characteristics of the target users in relation to the particular advertisement from among at least one group including the particular person.

12. The recording medium as claimed in claim 11, wherein the function of extracting groups extracts a group based on a degree of cohesion between users, or extracts users with strong cohesion between users as a group.

13. The method as claimed in claim 2, wherein the advertising information received in the step of receiving advertising information comprises characteristics of target users in relation to a particular advertisement, and the target group selected in the step of selecting a target group corresponds to a group related to the characteristics of the target users in relation to the particular advertisement from among at least one group including the particular person.

14. The method as claimed in claim 13, wherein, in the extracting groups, a group is extracted based on a degree of cohesion between users, or users with strong cohesion between users are extracted as a group.

15. The system as claimed in claim 6, wherein the advertising information received through the transceiver unit comprises characteristics of target users in relation to a particular advertisement, and the target group corresponds to a group related to the characteristics of the target users in relation to the particular advertisement from among at least one group including the particular person.

16. The system as claimed in claim 15, wherein the control unit extracts a group based on a degree of cohesion among users, or extracts users with strong cohesion between users as a group.

17. The recording medium as claimed in claim 10, wherein the advertising information received by performing the function of receiving advertising information comprises characteristics of target users in relation to a particular advertisement, and the target group selected by performing the function of selecting a target group corresponds to a group related to the characteristics of the target users in relation to the particular advertisement from among at least one group including the particular person.

18. The recording medium as claimed in claim 17, wherein the function of extracting groups extracts a group based on a degree of cohesion between users, or extracts users with strong cohesion between users as a group.
